(19) United States
(12) Patent Application Publication
(10) Pub. No.: US 2018/0091830 A1
(43) Pub. Date: Mar. 29, 2018

(54) SOURCE DEVICE AND DISPLAY APPARATUS

(71) Applicant: SAMSUNG ELECTRONICS CO., LTD., Suwon-si (KR)

(72) Inventors: Ho Yang CHOI, Suwon-si (KR); Eun Jae LEE, Seoul (KR)

(73) Assignee: SAMSUNG ELECTRONICS CO., LTD., Suwon-si (KR)

(21) Appl. No.: 15/710,024

(22) Filed: Sep. 20, 2017

(30) Foreign Application Priority Data
Sep. 26, 2016 (KR) 10-2016-0122949

(51) Int. Cl. H04N 21/218; G09G 3/3225; G09G 3/34; G09G 1/00

(52) U.S. Cl. CPC H04N 21/218; G09G 3/3225; G09G 2330/023; G09G 1/005; G09G 3/3406

(57) ABSTRACT

A source device includes a communication interface that communicates with a display apparatus, a memory, a first processor that processes an image, stores the processed first image in the memory, and transmits a pulse width modulation (PWM) signal to the display apparatus through the communication interface, and a second processor that transmits a second image stored in the memory to the display apparatus through the communication interface. In a first display mode, the first processor is configured to be deactivated after transmitting a PWM holding signal to the display apparatus through the communication interface.

### CROSS-REFERENCE TO RELATED APPLICATION(S)

This application claims the benefit under 35 U.S.C. § 119(a) of a Korean patent application filed on Sep. 26, 2016 in the Korean Intellectual Property Office and assigned Serial number 10-2016-0122949, the entire disclosure of which is hereby incorporated by reference.

### TECHNICAL FIELD

The present disclosure relates to a method for displaying an image in a display.

### BACKGROUND

With the development of electronic technologies, various types of electronic products are being developed and distributed. In particular, a display apparatus such as a television (TV), a monitor, or the like has been increasingly distributed in recent years.

The screen size of the display apparatus such as a TV, a monitor, or the like becomes larger, and the bezel or the thickness of the display apparatus becomes thinner. In addition, a product in which an image source processing device and a display panel are separated is being released to reduce the thickness of the display apparatus.

As the bezel and the thickness of the display apparatus become thinner, not only a stand-type display apparatus but also a wall-mounted display apparatus has been developed. In addition, the display apparatus may be used as a single ornament. For example, the display apparatus may operate as a frame by displaying a static image. However, in the case where the display apparatus continues to display the static image, power consumption considerably increases.

### SUMMARY

Aspects of the present disclosure address at least the above-mentioned problems and/or disadvantages and provide at least the advantages described below. Accordingly, an aspect of the present disclosure is to provide a source device and a display apparatus that are capable of reducing power consumption when an image is displayed.

In accordance with an aspect of the present disclosure, a source device includes a communication interface that communicates with a display apparatus, a memory, a first processor that processes an image, stores the processed first image in the memory, and transmits a pulse width modulation (PWM) signal to the display apparatus through the communication interface, and a second processor that transmits a second image stored in the memory to the display apparatus through the communication interface. In a first display mode, the first processor is configured to be deactivated after transmitting a PWM holding signal to the display apparatus through the communication interface.

The communication interface may comprise a first signal line configured to transmit the PWM signal and a second signal line configured to transmit the processed image. The first processor may be configured to deactivate the first signal line in the first display mode.

The source device may be configured to operate in the first display mode and in a second display mode. The first display mode may comprise transmitting a static image to the display apparatus. The second display mode may comprise transmitting a video image to the display apparatus.

The second processor may be configured to transmit the static image at a first frequency. In the second display mode, the second processor may be configured to transmit the video image at a second frequency, the second frequency being greater than the first frequency.

In accordance with an aspect of the present disclosure, a display apparatus includes a communication interface that communicates with a source device, a display panel, and a panel driving module that receives an image and a PWM signal from the source device through the communication interface, and to drive the display panel based on the image and the PWM signal. The panel driving module is configured to drive the display panel based on a last received PWM signal if a PWM holding signal is received from the source device through the communication interface.

The panel driving module may be configured to, in response to the PWM holding signal being received, store the last received PWM signal in an internal memory included in the panel driving module; and transmit the last received PWM signal, which is stored in the internal memory, to the display panel based on frequency information included in the PWM holding signal.

The communication interface may comprise a first signal line configured to receive the PWM signal; and a second signal line configured to receive the image. The first signal line may be configured to be deactivated in a first display mode.

The display panel may comprise a liquid crystal display (LCD) panel and a backlight. The panel driving module may be configured to drive the LCD panel by using the image; and drive the backlight by using the PWM signal.

The display panel may comprise an organic light emitting diode (OLED) panel. The panel driving module may be configured to drive the OLED panel by using the image and the PWM signal.

In accordance with an aspect of the present disclosure, a display apparatus includes a display panel, a panel driving module that drives the display panel, a memory, a first processor that processes an image, stores the processed first image in the memory, and transmits a PWM signal to the panel driving module, and a second processor that transmits the processed image, which is stored in the memory, to the panel driving module. The first processor is configured to be deactivated after transmitting a PWM holding signal to the panel driving module, if a display mode of the display apparatus is changed to a specified display mode.

The panel driving module may be configured to, in response to the PWM holding signal being received from the first processor, drive the display panel based on a last received PWM signal.

The panel driving module may be configured to, in response to the PWM holding signal being received, store the last received PWM signal in an internal memory included in the panel driving module; and transmit the PWM signal, which is stored in the internal memory, to the display panel based on frequency information included in the PWM holding signal.

The display apparatus may further comprise a first display mode and a second display mode. The first display mode may comprise transmitting a static image to the display apparatus. The second display mode may comprise transmitting a video image to the display apparatus.

The display panel may comprise a LCD panel and a backlight. The panel driving module may be configured to drive the LCD panel by using the image; and drive the backlight by using the PWM signal.

The display panel may comprise an OLED panel. The panel driving module may be configured to drive the OLED panel by using the image and the PWM signal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a display system, according to various embodiments of the present invention;

FIG. 2 is a block diagram illustrating a configuration of a source device, according to various embodiments of the present invention;

FIG. 3 is a block diagram illustrating a configuration of a display apparatus, according to various embodiments of the present invention;

FIG. 4A illustrates an operation of a display system in a second display mode, according to various embodiments of the present invention;

FIG. 4B illustrates an operation of a display system in a first display mode, according to various embodiments of the present invention;

FIG. 5 is a block diagram illustrating a configuration of a display apparatus, according to various embodiments of the present invention;

FIG. 6A illustrates an operation of a display system in a second display mode, according to various embodiments of the present invention;

FIG. 6B illustrates an operation of a display system in a first display mode, according to various embodiments of the present invention;

FIG. 7 is a flowchart illustrating a display method of a display system, according to various embodiments of the present invention; and

FIG. 8 is a flowchart illustrating a display method of a display apparatus, according to various embodiments of the present invention.

Throughout the drawings, it should be noted that like reference numbers are used to depict the same or similar elements, features, and structures.

### DETAILED DESCRIPTION

Hereinafter, various embodiments of the present invention may be described with reference to accompanying drawings. Accordingly, those of ordinary skill in the art will recognize that modification, equivalent, and/or alternative on the various embodiments described herein can be variously made without departing from the scope and spirit of the present invention. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specified embodiments and are not intended to limit the scope of the present invention. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude embodiments of this disclosure.

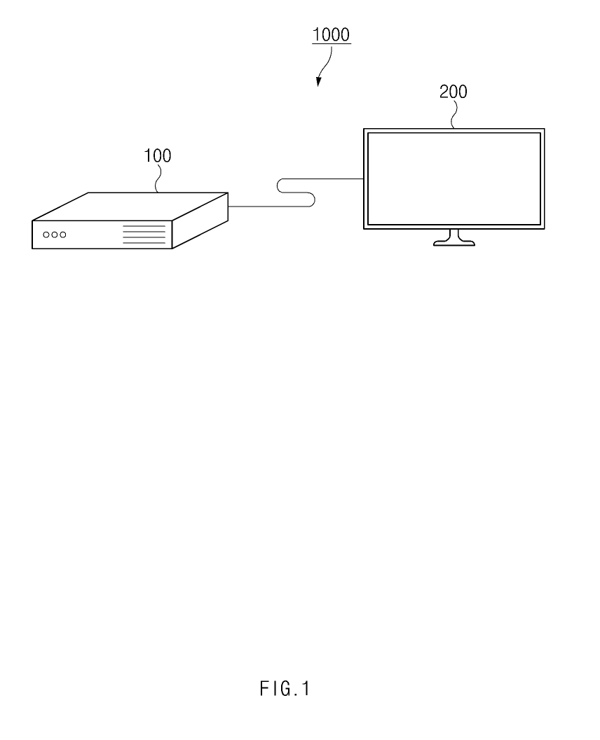

FIG. 1 is a block diagram illustrating a configuration of a display system, according to various embodiments of the present invention.

Referring to FIG. 1, a display system 1000 may include a source device 100 and a display apparatus 200. According to an embodiment, the display system 1000 may correspond to one display apparatus such as a television (TV), a monitor, or the like. For example, in the display system 1000, one display apparatus such as a conventional TV, a monitor, or the like may be divided into a device (e.g., the source device 100) that receives, processes, or stores content and a device (e.g., the display apparatus 200) that displays the content. For example, the source device 100 may transmit the content and a control signal needed to display the content to the display apparatus 200, and the display apparatus 200 may display an image based on the content and the control signal received from the source device 100. According to an embodiment, the source device 100 and the display apparatus 200 may be connected with each other by wire or wirelessly.

According to an embodiment, the source device 100 may transmit the content, which is received from an external device or is stored in an internal (or external) recording medium, to the display apparatus 200. The source device 100 may receive broadcast content from a broadcasting station over a broadcasting network or may receive web content from a web server via an Internet network, and the source device 100 may transmit the received content to the display apparatus 200. For another example, the source device 100 may receive content from an external source device (e.g., a set-top box, a game console (e.g., Xbox™, PlayStation™, or the like), a smartphone, a tablet PC, or the like) connected via a wired or wireless interface, and may transmit the received content to the display apparatus 200. For another example, the source device 100 may play the content stored in the recording medium and may transmit the played content to the display apparatus 200. For example, the recording medium may include a compact disc (CD), a digital versatile disc (DVD), a hard disk, a Blu-lay disc, a memory card, a USB memory, and the like. For example, the content may be content including an image and/or audio such as a movie, a drama, news, a game, a photograph, or the like.

According to an embodiment, the display apparatus 200 may receive the content from the source device 100. According to an embodiment, the display apparatus 200 may display the content received from the source device 100.

According to an embodiment, the display system 1000 may include a plurality of display modes. For example, the display system 1000 may include a first display mode for displaying a static image, a second display mode for displaying a video image (or a dynamic image), and a standby mode in which the display system 1000 does not display an image.

According to an embodiment, unlike the second display mode for displaying the video image, since the same image is displayed in the display apparatus 200 in the first display mode, image processing or transmission of a control signal may be omitted, and thus the power consumption may be reduced.

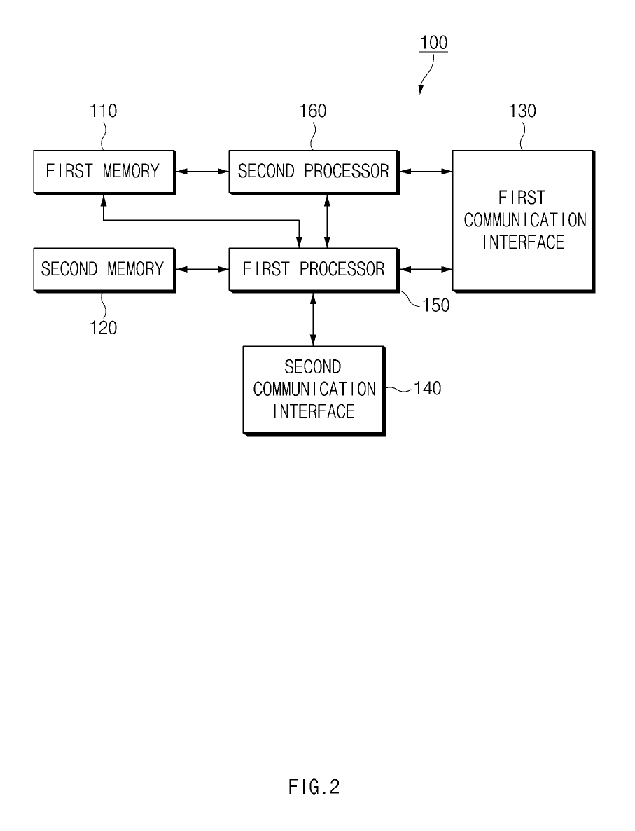

FIG. 2 is a block diagram illustrating a configuration of a source device, according to various embodiments of the present invention.

Referring to FIG. 2, the source device 100 may include a first memory 110, a second memory 120, a first communication interface (or a first communication circuit) 130, a second communication interface (or a second communication circuit) 140, a first processor 150, and a second processor 160.

According to an embodiment, the first memory 110 may store an image processed by the first processor 150. According to an embodiment, the first memory 110 may be a volatile memory or a nonvolatile memory. For example, the first memory 110 may include a random access memory (RAM). For another example, the first memory 110 may include a flash memory.

According to an embodiment, the second memory 120 may store an image. For example, the second memory 120 may store a static image displayed in a first display mode and a video image displayed in a second display mode. According to an embodiment, the second memory 120 may be a nonvolatile memory. For example, the second memory 120 may include a flash memory.

According to an embodiment, the first communication interface 130 may communicate with the display apparatus 200. According to an embodiment, the first communication interface 130 may transmit an image and a control signal (e.g., a pulse width modulation (PWM) signal or a PWM holding signal) to the display apparatus 200.

According to an embodiment, the first communication interface 130 may include a wired or wireless communication interface. For example, the first communication interface 130 may include at least one of a wired interface such as a high definition multimedia interface (HDMI) interface, a digital video interactive (DVI) interface, a display port (DP) interface, or the like and a wireless interface such as a wireless HD (WiHD) interface, a wireless gigabit (WiGig) interface, or the like. For example, the first communication interface 130 may include a serializer/deserializer (SerDes) interface.

According to an embodiment, the communication interface 130 may include a plurality of signal lines for transmitting data. For example, the plurality of signal lines may include a first signal line for transmitting the PWM signal or the PWM holding signal and a second signal line for transmitting an image.

According to an embodiment, the second communication interface 140 may communicate with an external device. According to an embodiment, the second communication interface 140 may communicate with an external source device. For example, the second communication interface 140 may receive content including an image from the external source device. According to an embodiment, the second communication interface 140 may communicate with a remote control device (not illustrated). For example, the second communication interface 140 may transmit the control signal to the remote control device or may receive the control signal from the remote control device.

According to an embodiment, the second communication interface 140 may include a wired or wireless communication interface. For example, the second communication interface 140 may include at least one of a wired interface such as a HDMI interface, a DVI interface, a DP interface, or the like and a wireless interface such as a WiHD interface, a WiGig interface, a Bluetooth interface, a near field communication (NFC) interface, a wireless fidelity (Wi-Fi) interface, an infrared ray (IR) interface, or the like.

According to an embodiment, the first processor 150 may control overall operations of the source device 100. For example, the first processor 150 may be a main processor of the source device 100. According to an embodiment, the first processor 150 may be implemented with a system on chip (SoC) that includes a central processing unit (CPU), a graphic processing unit (GPU), a memory, and the like.

According to an embodiment, the first processor 150 may process an image. For example, the first processor 150 may process an image stored in the second memory 120 or an image received from an external device through the second communication interface 140. For example, the first processor 150 may decode an image or may perform upscaling or downscaling such that the image is suitable for the screen size of the display apparatus 200. According to an embodiment, the first processor 150 may store the processed image in the first memory 110.

According to an embodiment, the first processor 150 may transmit the PWM signal to the display apparatus 200 through the first communication interface 130. For example, the first communication interface 130 may generate the PWM signal based on a characteristic of an image (e.g., a brightness of an image) to be displayed in the display apparatus 200 or user settings (e.g., a brightness setting value of a display) and may transmit the PWM signal to the display apparatus 200.

According to an embodiment, the first processor 150 may set the display mode of the source device 100. According to an embodiment, the first processor 150 may set the display mode of the source device 100 based on a control signal that is received from the remote control device through the second communication interface 140. According to an embodiment, if a specified event occurs, the first processor 150 may change the display mode of the source device 100. For example, if a specified time period expires, the first processor 150 may set the display mode of the source device 100 to a first display mode or a second display mode. For example, the specified time period may be set by a user.

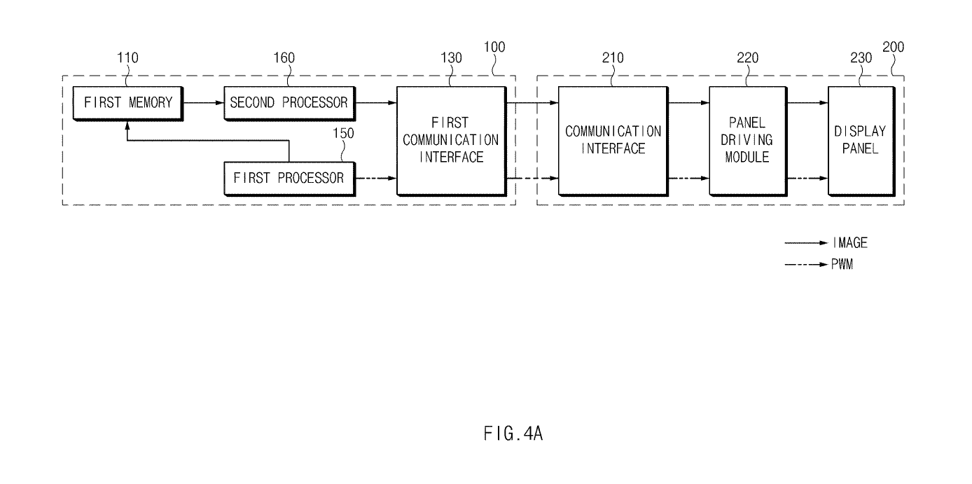

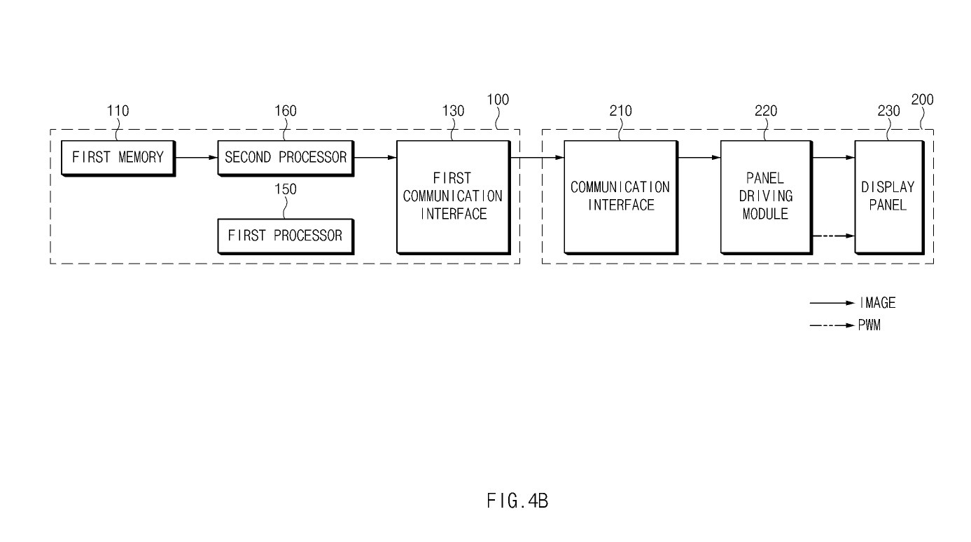

According to an embodiment, the first processor 150 may be activated or deactivated depending on the display mode of the source device 100 (or the display system 1000). This will be described with reference to FIGS. 4A and 4B.

According to an embodiment, the first processor 150 may change the display mode of the source device 100 (or the display system 1000) depending on a user input. For example, if the user input indicating entry to the first display mode is received, the first processor 150 may enter the first display mode. According to an embodiment, if the specified event occurs, the first processor 150 may change the display mode of the source device 100 (or the display system 1000). For example, if a specified time period (e.g., 10 minutes) expires in a standby mode, the first processor 150 may enter the first display mode. For another example, the first processor 150 may operate in the first display mode during a time period (e.g., from 10 a.m. to 5 p.m.) set by a user.

According to an embodiment, the second processor 160 may transmit the image, which is stored in the first memory 110, to the display apparatus 200 through the first communication interface 130. For example, the second processor 160 may receive information about an address of the first memory 110 from the first processor 150 and may transmit an image corresponding to the received address to the display apparatus 200. According to an embodiment, the second processor 160 may be a timing controller.

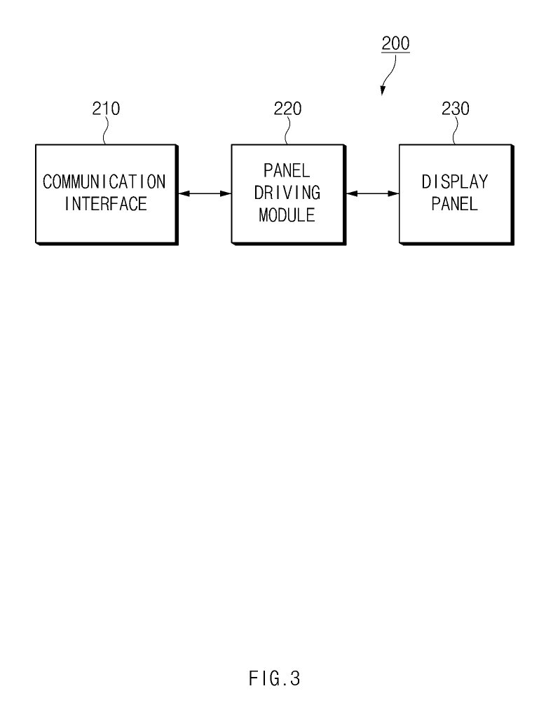

FIG. 3 is a block diagram illustrating a configuration of a display apparatus, according to various embodiments of the present invention.

Referring to FIG. 3, the display apparatus 200 may include a communication interface (or a communication circuit) 210, a panel driving module (or a panel driving circuit) 220, and a display panel 230.

According to an embodiment, the communication interface 210 may communicate with the source device 100. According to an embodiment, the communication interface 210 may receive an image and a control signal (e.g., a PWM signal or a PWM holding signal) from the source device 100. According to an embodiment, the communication interface 210 may include a wired or wireless interface. For example, the communication interface 210 may include at least one of a wired interface such as a HDMI interface, a DVI interface, a DP interface, or the like and a wireless interface such as a WiHD interface, a WiGig interface, or the like. For example, the communication interface 210 may include a SerDes interface.

According to an embodiment, the panel driving module 220 (or a panel driving integrated circuit (IC)) may drive the display panel 230. According to an embodiment, the panel driving module 220 may drive the display panel 230 based on the image and the PWM signal that are received from the source device 100. For example, the panel driving module 220 may generate a panel driving signal corresponding to the image received from the source device 100. For example, the panel driving signal may be a signal for controlling a voltage that is applied to each of a plurality of cells included in the display panel 230 so as to correspond to each of a plurality of pixels included in the image. The panel driving module 220 may transmit the panel driving signal and the PWM signal received from the source device 100 to the display panel 230.

According to an embodiment, the display panel 230 may display an image depending on the panel driving signal and the PWM signal that are received from the panel driving module 220. According to an embodiment, the display panel 230 may be a liquid crystal display (LCD) panel. For example, the display panel 230 may include the LCD panel and a backlight. The LCD panel may operate depending on the panel driving signal received from the panel driving module 220, and the backlight may irradiate light to the LCD panel depending on the PWM signal received from the panel driving module 220. According to an embodiment, the display panel 230 may be an organic light emitting diode (OLED) panel. For example, the display panel 230 may include the OLED panel having a plurality of OLED elements. The OLED panel may operate depending on the panel driving signal and the PWM signal received from the panel driving module 220.

FIG. 4A illustrates an operation of a display system in a second display mode, according to various embodiments of the present invention.

Referring to FIG. 4A, in the second display mode, the first processor 150 may process a video image and may store the video image in the first memory 110. According to an embodiment, the first processor 150 may transmit a PWM signal corresponding to the video image to the display apparatus 200 through the first communication interface 130. According to an embodiment, the first processor 150 may transmit the PWM signal at a second period. For example, the second period may correspond to a period (e.g., 1/120 sec or 1/240 sec) at which the display apparatus 200 displays an image in the second display mode. According to an embodiment, the first processor 150 may transmit the PWM signal at a second frequency. For example, the second frequency may correspond to a frequency (e.g., 120 Hz or 240 Hz) at which the display apparatus 200 displays an image in the second display mode.

According to an embodiment, the second processor 160 may transmit the video image stored in the first memory 110 to the display apparatus 200 through the first communication interface 130 in the second display mode. According to an embodiment, in the second display mode, the second processor 160 may transmit the video image at the second period.

According to an embodiment, the panel driving module 220 may receive an image and the PWM signal from the source device 100 through the communication interface 210 in the second display mode. According to an embodiment, the panel driving module 220 may drive the display panel 230 based on the image and the PWM signal that are received from the source device 100. The panel driving module 220 may generate a panel driving signal corresponding to the image received from the source device 100, and may transmit the panel driving signal and the PWM signal received from the source device 100 to the display panel 230. According to an embodiment, the display panel 230 may display the image depending on the panel driving signal and the PWM signal that are received from the panel driving module 220.

FIG. 4B illustrates an operation of a display system in a first display mode, according to various embodiments of the present invention.

Referring to FIG. 4B, in the first display mode, the first processor 150 may process a static image and may store the static image in the first memory 110. According to an embodiment, the first processor 150 may transmit a PWM signal corresponding to the static image to the display apparatus 200 through the first communication interface 130 in the first display mode. According to an embodiment, the first processor 150 may transmit the PWM signal at a first period. For example, the first period may correspond to a period (e.g., 1/60 sec or 1/120 sec) at which the display apparatus 200 displays the static image in the first display mode. For example, the first period may be longer than the second period. According to an embodiment, the first processor 150 may transmit the PWM signal at a first frequency. For example, the first frequency may correspond to a frequency (e.g., 60 Hz or 120 Hz) at which the display apparatus 200 displays the static image in the first display mode. For example, the first frequency may be lower than the second frequency.

According to an embodiment, the second processor 160 may transmit the static image stored in the first memory 110 to the display apparatus 200 through the first communication interface 130 in the first display mode. According to an embodiment, in the first display mode, the second processor 160 may transmit the static image at the first period or frequency.

According to an embodiment, the first processor 150 may transmit a PWM holding signal to the display apparatus 200 through the first communication interface 130 in the first display mode. For example, if entering the first display mode, the first processor 150 may transmit the PWM holding signal together with the PWM signal corresponding to the static image. For another example, if the PWM signal is transmitted the specified number of times (e.g., once) after entering the first display mode, the first processor 150 may transmit the PWM holding signal. According to an embodiment, after transmitting the PWM holding signal to the display apparatus 200, the first processor 150 may be deactivated. For example, if the PWM holding signal is transmitted, the first processor 150 may interrupt the processing of the static image, the generation of the PWM signal, and the transmission of the PWM signal. According to an embodiment, the PWM holding signal may include information about an output period or frequency of the PWM signal.

According to an embodiment, after transmitting the PWM holding signal, the first processor 150 may deactivate a part of the first communication interface 130. For example, the first processor 150 may deactivate a signal line for transmitting the PWM signal of the first communication interface 130.

According to an embodiment, the panel driving module 220 may receive an image and the PWM signal from the source device 100 through the communication interface 210 in the first display mode. According to an embodiment, the panel driving module 220 may drive the display panel 230 based on the image and the PWM signal received from the source device 100. The panel driving module 220 may generate a panel driving signal corresponding to the image received from the source device 100, and may transmit the panel driving signal and the PWM signal received from the source device 100 to the display panel 230. According to an embodiment, the display panel 230 may display an image depending on the panel driving signal and the PWM signal that are received from the panel driving module 220.

According to an embodiment, if the PWM holding signal is received from the source device 100, the panel driving module 220 may drive the display panel 230 based on the PWM signal that is received last. For example, if the PWM holding signal is received, the panel driving module 220 may store the last received PWM signal in an internal memory, and may transmit the stored PWM signal to the display panel 230. According to an embodiment, the panel driving module 220 may transmit the PWM signal to the display panel 230 based on information about an output period or frequency (e.g., the first period or first frequency) of the PWM signal, which is included in the PWM holding signal.

According to various embodiments of the present invention, the display system 1000 may deactivate the first processor 150 and a part of the first communication interface 130 in the first display mode, and may reduce the power consumption by reducing a driving frequency of the display panel 230.

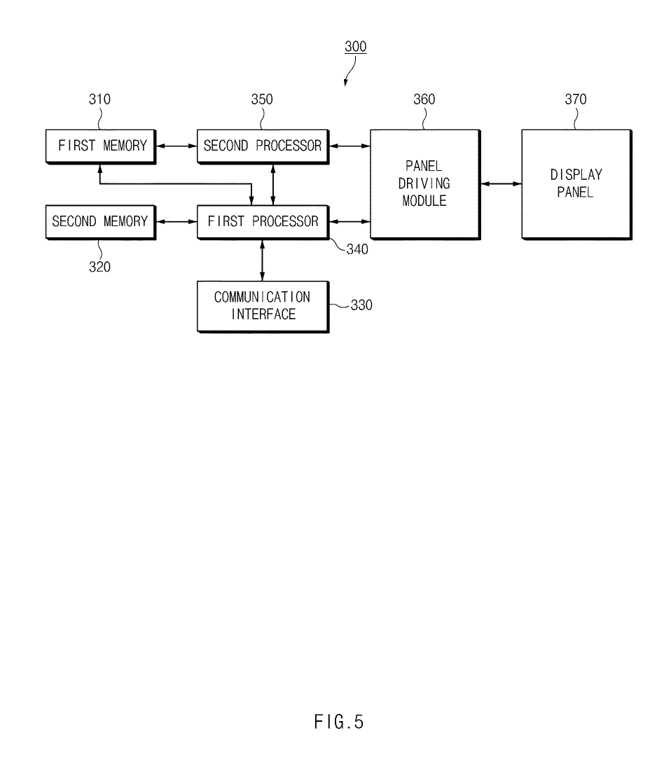

FIG. 5 is a block diagram illustrating a configuration of a display apparatus, according to various embodiments of the present invention.

Referring to FIG. 5, a display apparatus 300 may include a first memory 310, a second memory 320, a communication interface 330, a first processor 340, a second processor 350, a panel driving module (or a panel driving circuit) 360, and a display panel 370.

According to an embodiment, the display apparatus 300 illustrated in FIG. 5 may be the display system 1000 illustrated in FIG. 1 embodied in one device. According to an embodiment, the first memory 310, the second memory 320, the communication interface 330, the first processor 340, and the second processor 350 may correspond to the first memory 110, the second memory 120, the second communication interface 140, the first processor 150, and the second processor 160 of the source device 100 illustrated in FIG. 2, respectively. According to an embodiment, the panel driving module 360 and the display panel 370 may correspond to the panel driving module 220 and the display panel 230 of the display apparatus 200 illustrated in FIG. 3, respectively. Hereinafter, descriptions about elements, which are the same as elements of the source device 100 and the display apparatus 200, from among elements of the display apparatus 300 may be omitted, and differences thereof will be described below.

According to an embodiment, the display apparatus 300 may include a plurality of display modes. For example, the display apparatus 300 may include a first display mode for displaying a static image, a second display mode for displaying a video image (or a dynamic image), and a standby mode in which the display apparatus 300 does not display an image.

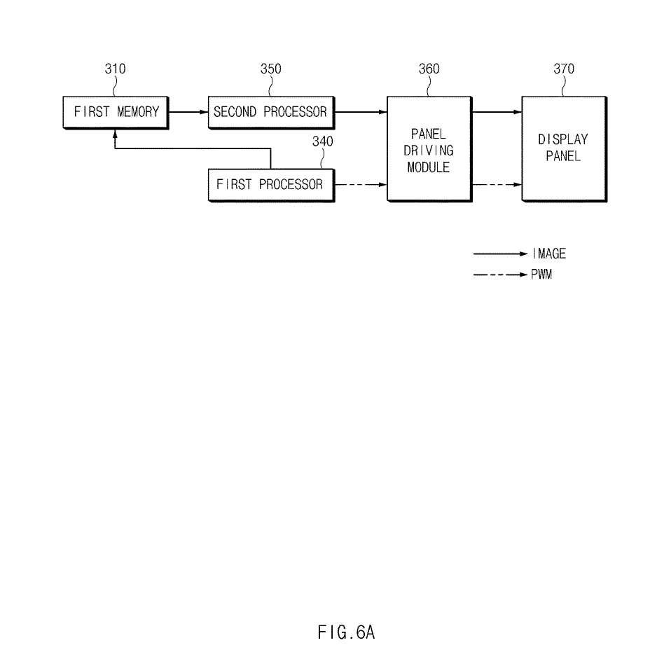

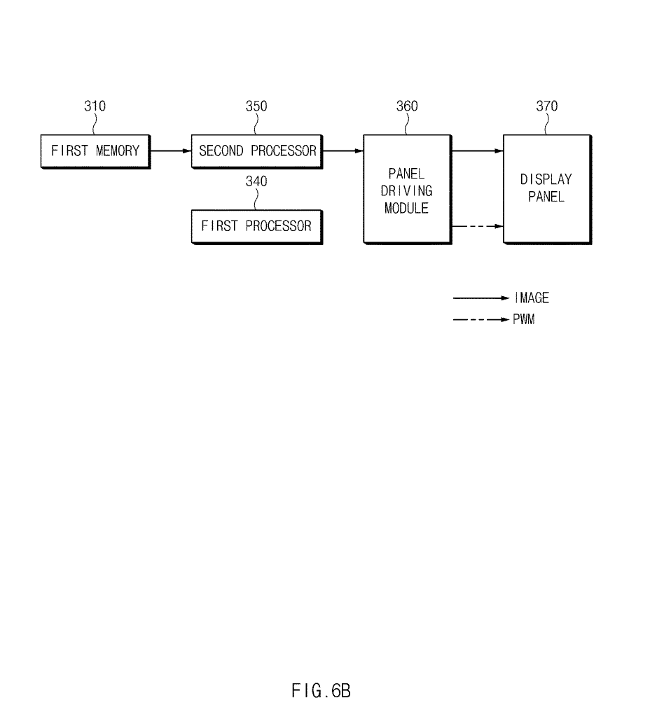

According to an embodiment, the first processor 340 may be activated or deactivated depending on a display mode of the display apparatus 300. This will be described with reference to FIGS. 6A and 6B.

FIG. 6A illustrates an operation of a display system in a second display mode, according to various embodiments of the present invention.

Referring to FIG. 6A, in the second display mode, the first processor 340 may process a video image and may store the video image in the first memory 310. According to an embodiment, the first processor 340 may transmit a PWM signal corresponding to the video image to the panel driving module 360. According to an embodiment, the first processor 340 may transmit the PWM signal at a second period. For example, the second period may correspond to a period (e.g., 1/120 sec or 1/240 sec) at which the display apparatus 300 displays an image in the second display mode. According to an embodiment, the first processor 340 may transmit the PWM signal at a second frequency. For example, the second frequency may correspond to a frequency (e.g., 120 Hz or 240 Hz) at which the display apparatus 300 displays an image in the second display mode

According to an embodiment, the second processor 350 may transmit the video image stored in the first memory 310 to the panel driving module 360 in the second display mode. According to an embodiment, in the second display mode, the second processor 350 may transmit the video image at the second period or frequency.

According to an embodiment, in the second display mode, the panel driving module 360 may drive the display panel 370 based on the video image, which is received from the second processor 350, and the PWM signal received from the first processor 340. The panel driving module 360 may generate a panel driving signal corresponding to the video image received from the second processor 350, and may transmit the panel driving signal and the PWM signal received from the first processor 340 to the display panel 370. According to an embodiment, the display panel 370 may display the video image depending on the panel driving signal and the PWM signal that are received from the panel driving module 360.

FIG. 6B illustrates an operation of a display system in a first display mode, according to various embodiments of the present invention.

Referring to FIG. 6B, in the first display mode, the first processor 340 may process a static image and may store the static image in the first memory 310. According to an embodiment, in the first display mode, the first processor 340 may transmit a PWM signal corresponding to the static image to the panel driving module 360. According to an embodiment, the first processor 340 may transmit the PWM signal at a first period. For example, the first period may correspond to a period (e.g., 1/60 sec or 1/120 sec) at which the display apparatus 300 displays the static image in the first display mode. For example, the first period may be longer than a second period. According to an embodiment, the first processor 340 may transmit the PWM signal at a first frequency. For example, the first frequency may correspond to a frequency (e.g., 60 Hz or 120 Hz) at which the display apparatus 300 displays the static image in the first display mode. For example, the first frequency may be longer than a second frequency.

According to an embodiment, the second processor 350 may transmit the static image stored in the first memory 310 to the panel driving module 360 in the first display mode. According to an embodiment, in the first display mode, the second processor 350 may transmit the static image at the first period or frequency.

According to an embodiment, in the first display mode, the first processor 340 may transmit a PWM holding signal to the panel driving module 360. For example, if entering the first display mode, the first processor 340 may transmit the PWM holding signal together with the PWM signal corresponding to the static image. For another example, if the PWM signal is transmitted the specified number of times (e.g., once) after entering the first display mode, the first processor 340 may transmit the PWM holding signal. According to an embodiment, after transmitting the PWM holding signal to the panel driving module 360, the first processor 340 may be deactivated. For example, if the PWM holding signal is transmitted, the first processor 340 may interrupt the processing of the static image, the generation of the PWM signal, and the transmission of the PWM signal. According to an embodiment, the PWM holding signal may include information about an output period or frequency of the PWM signal.

According to an embodiment, in the first display mode, the panel driving module 360 may drive the display panel 370 based on the static image, which is received from the second processor 350 and the PWM signal received from the first processor 340. The panel driving module 360 may generate a panel driving signal corresponding to the static image received from the second processor 350, and may transmit the panel driving signal and the PWM signal received from the first processor 340 to the display panel 370. According to an embodiment, the display panel 370 may display the static image depending on the panel driving signal and the PWM signal that are received from the panel driving module 360.

According to an embodiment, if the PWM holding signal is received from the first processor 340, the panel driving module 360 may drive the display panel 370 based on the PWM signal that is received last. For example, if the PWM holding signal is received, the panel driving module 360 may store the last received PWM signal in an internal memory, and may transmit the stored PWM signal to the display panel 370. According to an embodiment, the panel driving module 360 may transmit the PWM signal to the display panel 370 based on information about the output period or frequency (e.g., a first period or first frequency) of the PWM signal, which is included in the PWM holding signal.

According to various embodiments of the present invention, the display apparatus 300 may deactivate the first processor 340 in the first display mode, and may reduce the power consumption by reducing a driving frequency of the display panel 370.

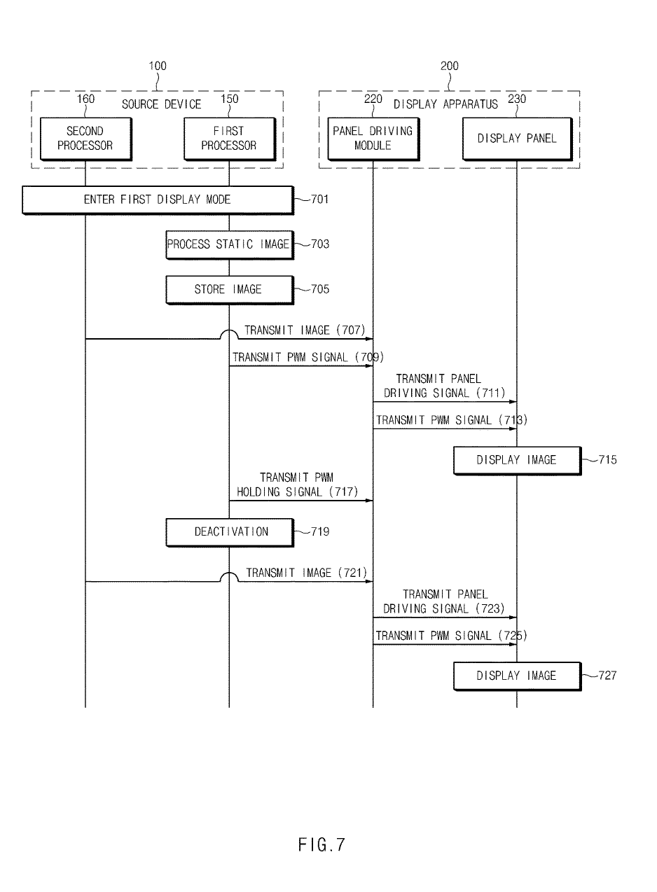

FIG. 7 is a flowchart illustrating a display method of a display system, according to various embodiments of the present invention.

According to an embodiment, in operation 701, the source device 100 may enter a first display mode. For example, if a user input is received or if a specified event occurs, the source device 100 may enter the first display mode.

According to an embodiment, in operation 703, the first processor 150 may process a static image. For example, the first processor 150 may process an image, which is stored in a nonvolatile memory (e.g., the second memory 120) or which is received from an external device through the second communication interface 140.

According to an embodiment, in operation 705, the first processor 150 may store the processed image in a memory (e.g., the first memory 110).

According to an embodiment, in operation 707, the second processor 160 may transmit an image to the display apparatus 200. For example, the second processor 160 may transmit the image, which is stored in the memory by the first processor 150, to the display apparatus 200.

According to an embodiment, in operation 709, the first processor 150 may transmit a PWM signal to the display apparatus 200. For example, the first processor 150 may transmit the PWM signal corresponding to the static image, which is stored in the memory, to the display apparatus 200.

According to an embodiment, operation 707 and operation 709 may be performed at the same time, or one of operation 707 and operation 709 may be performed first in terms of time.

According to an embodiment, in operation 711, the panel driving module 220 may transmit a panel driving signal to the display panel 230. For example, the panel driving module 220 may generate the panel driving signal corresponding to the image, which is received from the source device 100 in operation 707, and may transmit the generated panel driving signal to the display panel 230.

According to an embodiment, in operation 713, the panel driving module 220 may transmit the PWM signal to the display panel 230. For example, the panel driving module 220 may transmit the PWM signal received from the source device 100 to the display panel 230.

According to an embodiment, operation 711 and operation 713 may be performed at the same time, or one of operation 707 and operation 709 may be performed first in terms of time.

According to an embodiment, in operation 715, the display panel 230 may display an image. For example, the display panel 230 may display the image depending on the panel driving signal and the PWM signal that are received from the panel driving module 220.

According to an embodiment, in operation 717, the first processor 150 may transmit a PWM holding signal to the display apparatus 200. According to an embodiment, the PWM holding signal may include information about an output period or frequency of the PWM signal.

According to an embodiment, in operation 719, the first processor 150 may be deactivated. For example, after the PWM holding signal is transmitted, the first processor 150 may interrupt the processing of the static image, the generation of the PWM signal, and the transmission of the PWM signal.

According to an embodiment, in operation 721, the second processor 160 may transmit an image to the display apparatus 200. For example, the second processor 160 may transmit the image, which is stored in the memory by the first processor 150, to the display apparatus 200. According to an embodiment, the second processor 160 may transmit the same image as an image that is transmitted to the display apparatus 200 in operation 707.

According to an embodiment, in operation 723, the panel driving module 220 may transmit the panel driving signal to the display panel 230. For example, the panel driving module 220 may generate the panel driving signal corresponding to the image, which is received from the source device 100 in operation 721, and may transmit the generated panel driving signal to the display panel 230.

According to an embodiment, in operation 725, the panel driving module 220 may transmit the PWM signal to the display panel 230. For example, if the PWM holding signal is received in operation 717, the panel driving module 220 may store the last received PWM signal in an internal memory, and may transmit the stored PWM signal to the display panel 230. According to an embodiment, the panel driving module 220 may transmit the PWM signal to the display panel 230 based on information about the output period or frequency (e.g., a first period or first frequency) of the PWM signal, which is included in the PWM holding signal.

According to an embodiment, in operation 727, the display panel 230 may display the image. For example, the display panel 230 may display the image depending on the panel driving signal and the PWM signal that are received from the panel driving module 220.

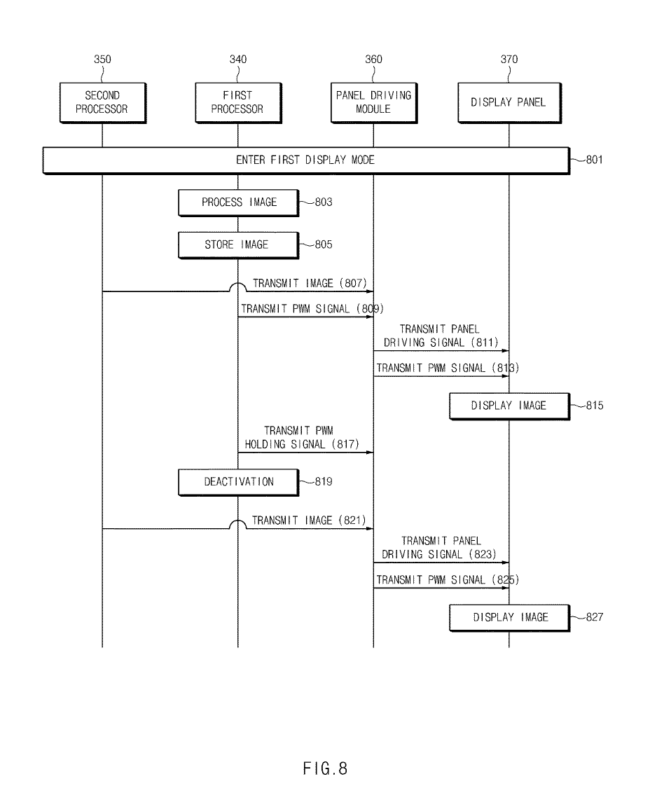

FIG. 8 is a flowchart illustrating a display method of a display apparatus, according to various embodiments of the present invention.

According to an embodiment, in operation 801, the display apparatus 300 may enter a first display mode. For example, if a user input is received or if a specified event occurs, the display apparatus 300 may enter the first display mode.

According to an embodiment, in operation 803, the first processor 340 may process a static image. For example, the first processor 340 may process an image, which is stored in a nonvolatile memory (e.g., the second memory 320) or which is received from an external device through the communication interface 330.

According to an embodiment, in operation 805, the first processor 340 may store the processed image in a memory (e.g., the first memory 310).

According to an embodiment, in operation 807, the second processor 350 may transmit an image to the display apparatus 200. For example, the second processor 350 may transmit the image, which is stored in the memory by the first processor 340, to the panel driving module 360.

According to an embodiment, in operation 809, the first processor 340 may transmit a PWM signal to the panel driving module 360. For example, the first processor 340 may transmit the PWM signal corresponding to the static image, which is stored in the memory, to the panel driving module 360.

According to an embodiment, operation 807 and operation 809 may be performed at the same time, or one of operation 807 and operation 809 may be performed first in terms of time.

According to an embodiment, in operation 811, the panel driving module 360 may transmit a panel driving signal to the display panel 370. For example, the panel driving module 360 may generate the panel driving signal corresponding to the image, which is received from the second processor 350 in operation 807, and may transmit the generated panel driving signal to the display panel 370.

According to an embodiment, in operation 813, the panel driving module 360 may transmit the PWM signal to the display panel 370. For example, the panel driving module 360 may transmit the PWM signal received from the first processor 340 to the display panel 370.

According to an embodiment, operation 811 and operation 813 may be performed at the same time, or one of operation 811 and operation 813 may be performed first in terms of time.

According to an embodiment, in operation 815, the display panel 370 may display the image. For example, the display panel 370 may display the image depending on the panel driving signal and the PWM signal that are received from the panel driving module 360.

According to an embodiment, in operation 817, the first processor 340 may transmit a PWM holding signal to the panel driving module 360. According to an embodiment, the PWM holding signal may include information about an output period or frequency of the PWM signal.

According to an embodiment, in operation 819, the first processor 340 may be deactivated. For example, after the PWM holding signal is transmitted, the first processor 340 may interrupt the processing of the static image, the generation of the PWM signal, and the transmission of the PWM signal.

According to an embodiment, in operation 821, the second processor 350 may transmit an image to the panel driving module 360. For example, the second processor 350 may transmit the image, which is stored in the memory by the first processor 340, to the panel driving module 360. According to an embodiment, the second processor 350 may transmit the same image as an image that is transmitted to the panel driving module 360 in operation 807.

According to an embodiment, in operation 823, the panel driving module 360 may transmit the panel driving signal to the display panel 370. For example, the panel driving module 360 may generate the panel driving signal corresponding to the image, which is received from the second processor 350 in operation 821, and may transmit the generated panel driving signal to the display panel 370.

According to an embodiment, in operation 825, the panel driving module 360 may transmit the PWM signal to the display panel 370. For example, if the PWM holding signal is received in operation 817, the panel driving module 360 may store the last received PWM signal in an internal memory, and may transmit the stored PWM signal to the display panel 370. According to an embodiment, the panel driving module 360 may transmit the PWM signal to the display panel 370 based on information about the output period or frequency (e.g., a first period or first frequency) of the PWM signal, which is included in the PWM holding signal.

According to an embodiment, in operation 827, the display panel 370 may display the image. For example, the display panel 370 may display the image depending on the panel driving signal and the PWM signal that are received from the panel driving module 360.

The term “module” used herein may include a unit, which is implemented with hardware, software, or firmware, and may be interchangeably used with the terms “logic”, “logical block”, “component”, “circuit”, or the like. The “module” may be a minimum unit of an integrated component or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

According to various embodiments, at least a part of an apparatus (e.g., modules or functions thereof) or a method (e.g., operations) may be, for example, implemented by instructions stored in a computer-readable storage media in the form of a program module. The instruction, when executed by a processor, may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The instruction may include codes created by a compiler or codes that are capable of being executed by a computer by using an interpreter. According to various embodiments, a module or a program module may include at least one of the above elements, or a part of the above elements may be omitted, or other elements may be further included.

According to various embodiments of the present invention, when the display apparatus displays a static image, the power consumption may be reduced.

According to various embodiments, operations executed by modules, program modules, or other elements may be executed by a successive method, a parallel method, a repeated method, or a heuristic method, or at least one part of operations may be executed in different sequences or omitted. Alternatively, other operations may be added. While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A source device, comprising:
a communication interface configured to communicate with a display apparatus;
a memory;
a first processor configured to process an image, to store the processed image in the memory, and to transmit a pulse width modulation (PWM) signal to the display apparatus through the communication interface; and
a second processor configured to transmit the processed image stored in the memory to the display apparatus through the communication interface,
wherein in a first display mode, the first processor is configured to be deactivated after transmitting a PWM holding signal to the display apparatus through the communication interface.

2. The source device of claim 1, wherein the communication interface comprises:
a first signal line configured to transmit the PWM signal; and
a second signal line configured to transmit the processed image,
wherein the first processor is configured to deactivate the first signal line in the first display mode.

3. The source device of claim 1, wherein the source device is configured to operate in the first display mode and in a second display mode,
wherein the first display mode comprises transmitting a static image to the display apparatus, and
wherein the second display mode comprises transmitting a video image to the display apparatus.

4. The source device of claim 3, wherein in the first display mode, the second processor is configured to transmit the static image at a first frequency, and
wherein in the second display mode, the second processor is configured to transmit the video image at a second frequency, the second frequency being greater than the first frequency.

5. A display apparatus, comprising:
a communication interface configured to communicate with a source device;
a display panel; and
a panel driving module configured to receive an image and a PWM signal from the source device through the communication interface, and to drive the display panel based on the image and the PWM signal,
wherein the panel driving module is configured to, in response to a PWM holding signal being received from the source device through the communication interface, drive the display panel based on a last received PWM signal.

6. The display apparatus of claim 5, wherein the panel driving module is configured to, in response to the PWM holding signal being received:
store the last received PWM signal in an internal memory included in the panel driving module; and
transmit the last received PWM signal, which is stored in the internal memory, to the display panel based on frequency information included in the PWM holding signal.

7. The display apparatus of claim 5, wherein the communication interface comprises:
a first signal line configured to receive the PWM signal; and
a second signal line configured to receive the image,
wherein the first signal line is configured to be deactivated in a first display mode.

8. The display apparatus of claim 5,
wherein the display panel comprises a liquid crystal display (LCD) panel and a backlight,
wherein the panel driving module is configured to:
drive the LCD panel by using the image; and
drive the backlight by using the PWM signal.

9. The display apparatus of claim 5,
wherein the display panel comprises an organic light emitting diode (OLED) panel,
wherein the panel driving module is configured to drive the OLED panel by using the image and the PWM signal.

10. A display apparatus comprising:
a display panel;
a panel driving module configured to drive the display panel;
a memory;
a first processor configured to process an image, to store the processed image in the memory, and to transmit a PWM signal to the panel driving module; and
a second processor configured to transmit the processed image, which is stored in the memory, to the panel driving module,
wherein the first processor is configured to, in response to a display mode of the display apparatus being changed to a specified display mode, be deactivated after transmitting a PWM holding signal to the panel driving module.

11. The display apparatus of claim 10, wherein the panel driving module is configured to, in response to the PWM holding signal being received from the first processor, drive the display panel based on a last received PWM signal.

12. The display apparatus of claim 11, wherein the panel driving module is configured to, in response to the PWM holding signal being received:
store the last received PWM signal in an internal memory included in the panel driving module; and
transmit the PWM signal, which is stored in the internal memory, to the display panel based on frequency information included in the PWM holding signal.

13. The display apparatus of claim 10,
wherein the display apparatus comprises a first display mode and a second display mode,
wherein the first display mode comprises transmitting a static image to the display apparatus, and
wherein the second display mode comprises transmitting a video image to the display apparatus.

14. The display apparatus of claim 13, wherein in the first display mode, the second processor is configured to transmit the static image at a first frequency, and
wherein in the second display mode, the second processor is configured to transmit the video image at a second frequency, the second frequency being greater than the first frequency.

15. The display apparatus of claim 10,
wherein the display panel comprises a LCD panel and a backlight, and
wherein the panel driving module is configured to:
drive the LCD panel by using the image; and
drive the backlight by using the PWM signal.

16. The display apparatus of claim 10,
wherein the display panel comprises an OLED panel, and
wherein the panel driving module is configured to drive the OLED panel by using the image and the PWM signal.
